(19) United States
(12) Patent Application Publication
(10) Pub. No.: US 2023/0235587 A1
(43) Pub. Date: Jul. 27, 2023

(54) Vehicle Vacuum Storage Enclosure

(71) Applicant: Charles H. Olk, Almont, MI (US)

(72) Inventor: Charles H. Olk, Almont, MI (US)

(21) Appl. No.: 16/268,834

(22) Filed: Feb. 6, 2019

(51) Int. Cl. E04H 6/02

(52) U.S. Cl. CPC E04H 6/02

(57) ABSTRACT

Storage of vehicles either long term or seasonal presents a problem of protecting them from an environment that can lead to oxidation damage and corrosion. The Vehicle Vacuum Storage Enclosure can be vacuum sealed, the air is remove from the enclosure which reduces water and oxygen levels in the enclosure thereby reducing oxidation and corrosion of parts on the vehicle enclosed. The enclosure is designed so that a vehicle can be placed on the bottom side of the enclosure then using the seals the vehicle is completely surrounded by the air tight enclosure. The air in the enclosure is then evacuated through the vacuum port/valve and vehicle remains under vacuum for the duration of the storage period as the port/valve and the seals prevent air from entering the enclosure.

### BACKGROUND

storage of vehicles either long term or seasonal presents the problem of protecting them and their parts from the environment which can lead to oxidation damage (corrosion).

### BRIEF SUMMARY OF THE INVENTION

The Vehicle Vacuum Storage Enclosure can enclose any vehicle under a vacuum seal, The air is remove from the enclosure that reduces water vapor and oxygen levels in the enclosure thereby reducing oxidation and corrosion of parts on the vehicle enclosed. The Vehicle Vacuum Storage Enclosure is comprised of a flexible enclosure, that envelops the vehicle and is vacuum sealed. Air is remove from the enclosure to reduces water and oxygen levels within the enclosure thereby reducing oxidation of parts on the vehicle enclosed. An inert gas may be introduced into the enclosure after air evacuation. The enclosure may be any dimensions large enough to completely contain a vehicle (e.g. car, truck, tractor, motorcycle, etc.). The enclosure may be composed of a material impervious or near impervious to diffusing air through it, The enclosure uses one or more air tight seals long enough to allow the loading of the vehicle and will keep air from entering or exiting the enclosure. The enclosure possesses a vacuum port/valve for pumping air out of the enclosure that also prohibits the transport of air back into the enclosure thereby, maintaining a vacuum.

### BRIEF DESCRIPTION OF THE DRAWINGS

FIG. 1. An enclosure may have any number of sides and perimeters provided they form an enclosure capable of completely enveloping the vehicle and sealing the enclosure from the external environment. This figure shows a cylindrical enclosure with vacuum seal for loading and a vacuum valve for evacuation.

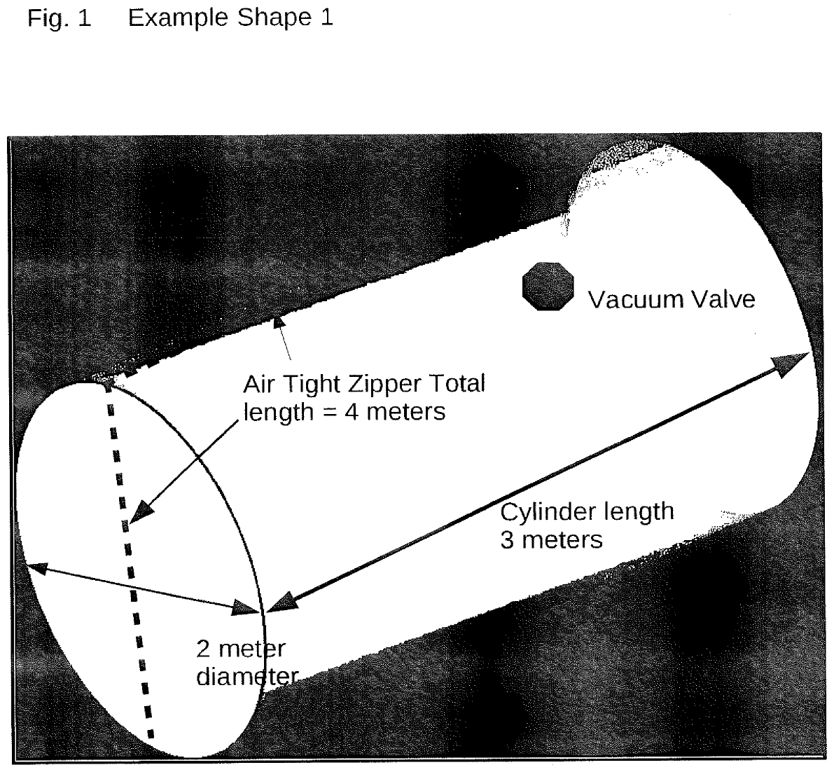

FIG. 2. An enclosure may have any number of sides and perimeters provided they form an enclosure capable of completely enveloping the vehicle and sealing the enclosure from the external environment. This figure shows a capsule enclosure with vacuum seal for loading and a vacuum valve for evacuation.

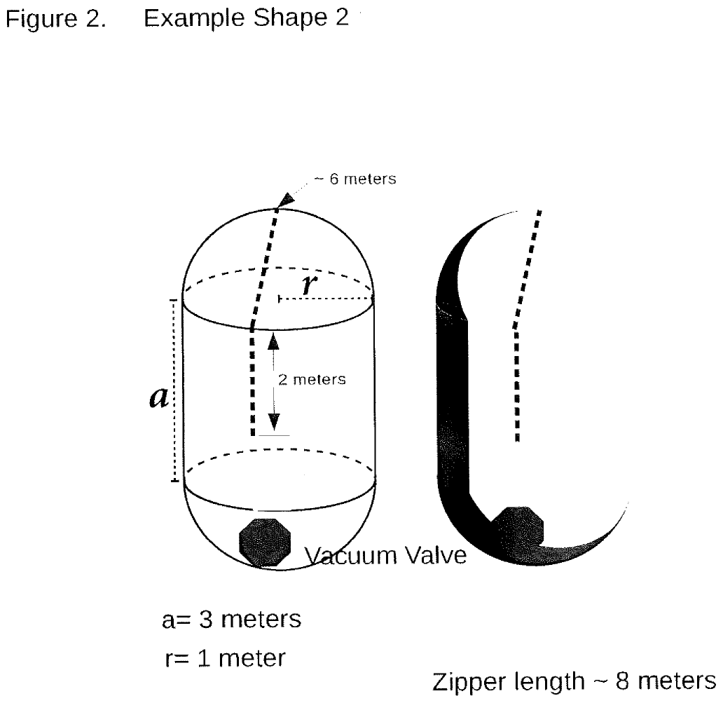

### DETAILED DESCRIPTION AND BEST MODE OF IMPLEMENTATION

An enclosure that envelops the vehicle and can be vacuum sealed. Air is remove from the enclosure thereby reducing water and oxygen levels in the enclosure resulting in a reduction of oxidation and corrosion of parts on the vehicle enclosed. An inert gas may be introduced into the enclosure after air evacuation. The enclosure may be any dimensions large enough to completely contain a vehicle (e.g. car, truck, tractor, motorcycle, ATV, etc.). The enclosure may be composed of a material near-impervious or impervious to air diffusing through it. The enclosure uses one or more air tight seals to enclose and keep air from entering or exiting the enclosure. The enclosure possesses a vacuum port/valve for pumping air in or out of the enclosure. The port/valve is also able to prohibit the transport of air through into and out of the enclosure.

Vacuum Sealed: vacuum pumped (air removal) to a maximum of 50% air content or lower. The vacuum level is determined by the pumping rate of the pump used to evacuate the enclosure and the shear strength of the enclosure material. Typically, a household or shop vacuum can suffice.

Enclosure: this device forms a boundary between the vehicle and the surrounding environment (e.g. bag, box, package, envelope, or container).

Vehicle: e.g. car, truck, tractor, motorcycle, ATV, bicycle, boat, trike, watercraft, snow craft, etc.

Material: polymer or coated polymer with a low air permeability (e.g. plastic, metal or ceramic coated plastic or polymer).

Seal: a method for forming an air tight enclosure out of the enclosure material (e.g. zipper, melt forming or bond seal, slide lock zip-like lock, etc).

Vacuum Port: two way or one way valve for removing the air from the interior of the enclosure.

1. An enclosure that can be vacuum sealed. When air is remove from the enclosure water and oxygen are removed to levels much lower than the ambient environment. Within the evacuated enclosure there will be reduce oxidation and corrosion of parts on the vehicle enclosed.
